(19) United States
(12) Patent Application Publication
(10) Pub. No.: US 2011/0154399 A1
(43) Pub. Date: Jun. 23, 2011

(54) CONTENT RECOMMENDATION ENGINE

(75) Inventors: Zhiying Jin, Lexington, MA (US); Alexander Sakharov, Natick, MA (US); Jianxiu Hao, Lexington, MA (US)

(73) Assignee: VERIZON PATENT AND LICENSING, INC., Basking RIdge, NJ (US)

(21) Appl. No.: 12/644,671

(22) Filed: Dec. 22, 2009

(51) Int. Cl. H04N 5/445

(52) U.S. Cl. 725/46

(57) ABSTRACT

A method may include determining a program currently being displayed for a user to watch and selecting a program to recommend to the user based on the program currently being displayed by the user and based on an availability of the program to recommend. The method may include displaying an indication of the recommended program to the user.

### BACKGROUND INFORMATION

The set-top box (“STB”) allows television (“TV”) viewers to access a large amount and variety of content offered by a provider. For example, the viewer may choose between broadcast TV programs, pay-per-view programs, on-demand programs, interactive games, or music, all through the STB. The large amount of content offered by providers can make it difficult for the viewer to find and select desired content. On-screen program guides may help viewers, but as the amount of content continues to expand, even on-screen program guides are inadequate.

### BRIEF DESCRIPTION OF THE DRAWINGS

FIG. 1 is a diagram of an overview of an exemplary embodiment described herein;

FIG. 2 is a diagram of an exemplary environment for implementing embodiments described herein;

FIG. 3 is a block diagram of exemplary components of a computing module;

FIG. 4 is a block diagram of exemplary functional components and/or memory components of the matching server of FIG. 2;

FIG. 5 is a block diagram of exemplary functional components and/or memory components of the video client of FIG. 2;

FIG. 6 is a diagram of an exemplary metadata table;

FIG. 7 is a diagram of an exemplary attribute table;

FIG. 8 is a diagram of an exemplary correlation table;

FIG. 9 is a diagram of an exemplary match table;

FIG. 10 is a flowchart of an exemplary process for determining attributes of content;

FIGS. 11A and 11B are flowcharts of an exemplary process for scoring the correlation of pairs of content; and

FIG. 12 is a flowchart of an exemplary process for recommending content.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

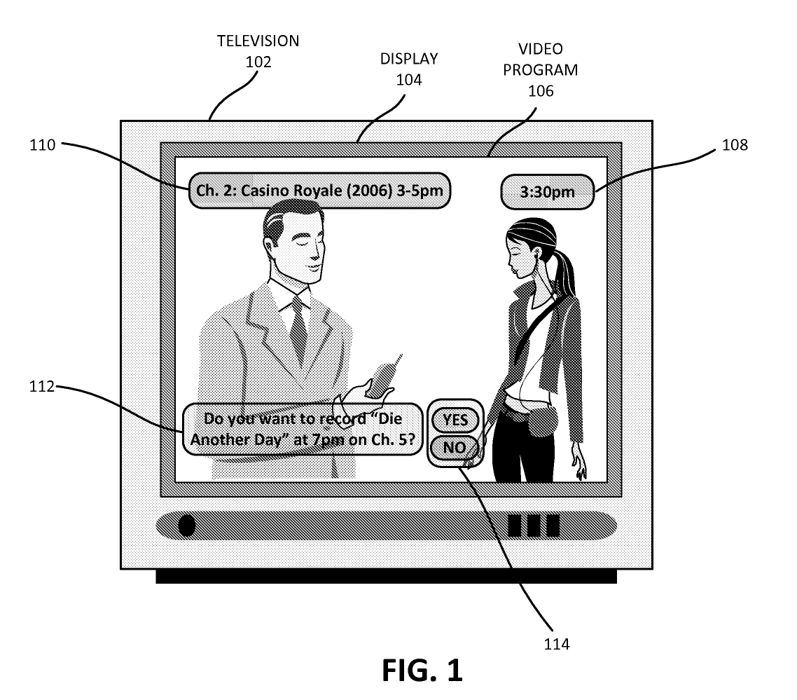

One or more embodiments disclosed herein allow for the recommendation of content to a viewer watching television. FIG. 1 is a diagram of an overview of an exemplary embodiment including a television 102 in a customer's home. As shown in FIG. 1, television 102 includes a display 104, which displays a video program 106. Superimposed on video program 106 are graphical widgets 108, 110, 112, and 114. Widget 108 displays the current time (e.g., 3:30 pm). Widget 110 displays the name of program 106 (e.g., “Casino Royale”), the time program 106 is playing (e.g., from 3-5 pm), and its channel (e.g., channel 2). Some embodiments allow for the recommendation of another television program based on the program currently being watched by the user (e.g., in real-time). For example, widget 112 recommends another program to the user, e.g., “Die Another Day,” playing at 7 pm, and asks whether the user would like to record the recommended program. Embodiments may select the recommended program based on similarities between program 106 currently being watched and the recommended program. Widget 114 allows the user to respond to the recommendation with a “Yes” or a “No.”

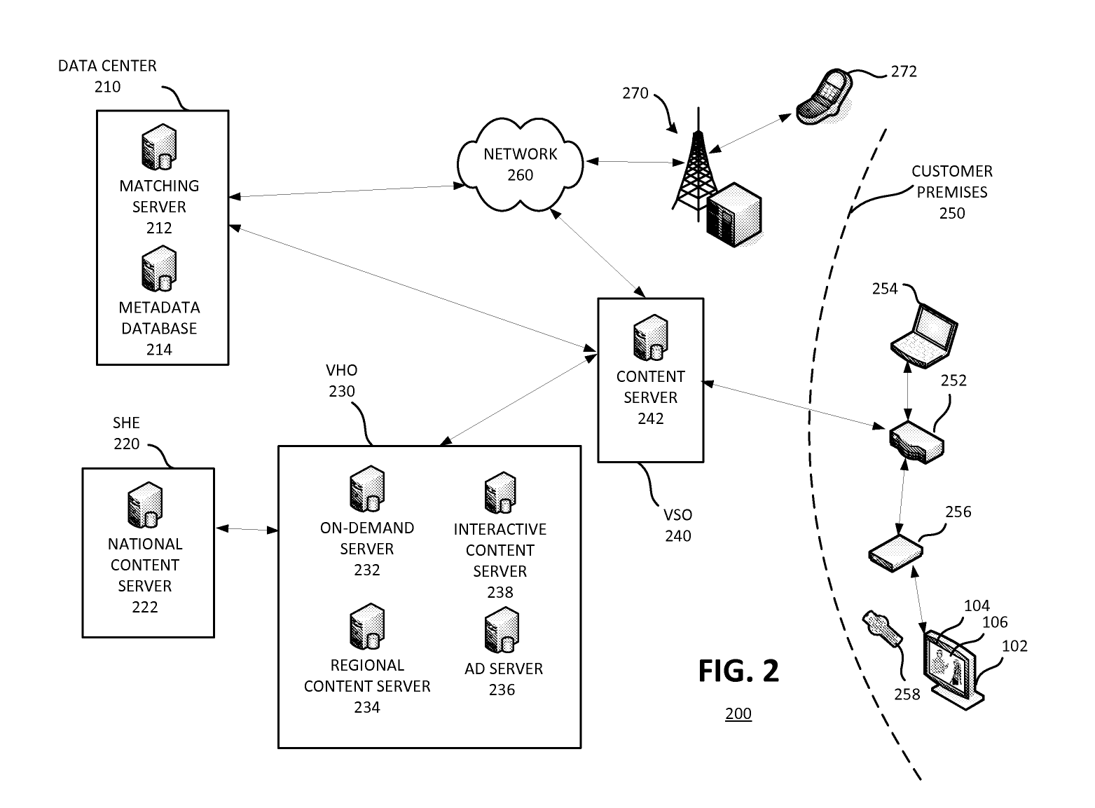

FIG. 2 is a diagram of an exemplary network 200 for implementing embodiments described herein. Network 200 may include a data center 210, a super head end (SHE) 220, a video hub office (VHO) 230, a video service office (VSO) 240, customer premises 250, a network 260, a base station system (BSS) 270, and a mobile device 272. As with FIG. 1, customer premises 250 (e.g., the customer's home) includes TV 102 having display 104 showing program 106. A number of the components of FIG. 2 may operate together to implement a content (e.g., TV program) recommendation system.

VSO 240 may deliver content or data to customer premises 250 (e.g., a customer's home) from VSO 240 and/or data center 210. Data center 210 may include components that manage and/or store information associated with the content recommendation system. As shown in FIG. 2, data center 210 may include a matching server 212 and a metadata database 214.

Metadata database 214 may include a server that stores information about content. For a video, for example, metadata database 214 may store the title, genre, plot, director, cast, etc., of the video. Metadata database 214 may also store information about content other than videos, such as interactive games or music. As used herein, the term “program” may refer to any type of content, such as TV programs, movies, interactive games, audio, radio, etc. Matching server 212 may use metadata database 214 to determine which pieces of content correlate well with each other and, based on the correlations, may recommend content for a user.

SHE 220 may include a national content server 222. National content server 222 may include a source of for-pay television broadcasts (e.g., TNT, ESPN, HBO, Cinemax, CNN, etc.). VHO 230 may include an on-demand server 232, a regional content server 234, an advertisement (ad) server 236, and an interactive content server 238. Collectively, national content server 222, on-demand server 232, regional content server 234, ad server 236, and interactive content server 238 may be referred to as “content servers 222-238.”

Regional content server 234 may provide television broadcasts (e.g., local broadcasts, such as NBC, CBS, ABC, and Fox). On-demand server 232 may provide on-demand services (e.g., video, music, and/or games on-demand). On-demand server 232 may include a database (not shown) that may store on-demand content that may be provided by on-demand server 232. Ad server 236 may control the advertising content (e.g., commercials) that is presented with content, such as the national and/or regional content. Ad server 236 may include interactive content that may be interpreted by a video client (e.g., video client 256) displaying content on, for example, a display (e.g., display 104) of a television.

Interactive content server 238 may serve and manage interactive content (e.g., any form of content with which a user can interact). For example, interactive content may include an interactive program guide, an interactive game, or interactive advertisements.

VSO 240 may include components to collect and deliver content (e.g., interactive video content) to customer premises 250 and to receive data from customer premises 250 for forwarding to the proper destination (e.g., network 260 or interactive content server 238). VSO 240 may include a content server 242. Content server 242 may include a content mixing engine (e.g., a multiplexer/demultiplexer) to select information, such as on-demand content, regional and national video content, interactive content, and/or advertising content, and mix the information together. Content server 242 may also receive data from customer premises 250 for delivery to any one of servers 212-238 or any device coupled to network 260 (e.g., any device coupled to the Internet). Content server 242 may also perform transcoding of the mixed information and/or encoding or encryption functions.

Network 260 may include one or more packet switched networks, such as an Internet protocol (IP) based network, a local area network (LAN), a wide area network (WAN), a personal area network (PAN), an intranet, the Internet, or another type of network that is capable of transmitting data. Network 260 may include a circuit-switched network, such as a public-switched telephone network (PSTN) for providing telephone services for traditional telephones. Network 260, in conjunction with components in VSO 240, may allow devices at customer premises 250 (e.g., computer 254 and/or video client 256) to connect to other devices also attached to network 260, such as third party web site servers (not shown) or other customers (not shown).

BSS 270 may control traffic and signaling with a mobile device. BSS 270 may include an antenna to transmit and receive signals to and from a mobile device, such as mobile device 272. Mobile device 272 may include a radiotelephone, a personal communications system (PCS) terminal, a personal digital assistant (PDA), a laptop, or another portable communication device.

Customer premises 250 (e.g., a customer's home) may connect to VSO 240. Customer premises 250 may include an optical network terminal (ONT) 252, a video client 256, a computer 254, a TV 102, and a remote control 258. ONT 252 may receive data, e.g., on a fiber optic cable, and may transfer the data to the appropriate device in customer premises 250, such as a telephone (not shown), computer 254, a router (not shown), or video client 256. Likewise, ONT 252 may receive data from any device in customer premises 250 and may transmit the data to other devices in network 200, e.g., through a fiber optic cable.

Video client 256 (e.g., a set-top box) may receive content from content server 242, for example, and output the content to display 104. In some embodiments, the content may be obtained from content servers 222-238. Although video client 256 may include a set-top box, video client 256 may include a component (e.g., a cable card or a software package) that plugs into a host device (e.g., a digital video recorder (DVR), a personal computer, a television, stereo system, etc.) and allows the host device to display content (e.g., multimedia content on television channels). Video client 256 may also be implemented as a home theater personal computer (HTPC), an optical disk player (e.g., digital video disk (DVD) or Blu-Ray™ disc player), a cable card, etc. Video client 256 may receive commands from remote control 258 and/or any component in network 200.

Remote control 258 may issue wired or wireless commands for controlling other electronic devices, such as TV 102 or video client 256. Remote control 258, in conjunction with video client 256, may allow a user to manually select TV programs to view on display 104. In one embodiment, remote control 258 may be used in conjunction with video client 256 to record or watch content having been recommended by matching server 212, for example. Other types of devices (e.g., a keyboard, mouse, a mobile phone, etc.) may be used instead of remote control 258.

TV 102 may include speakers and display 104. Display 104 may play content received from content server 242 or from a DVR (e.g., a DVR in a STB). Although TV 102 includes display 104, in other embodiments, any device capable of receiving and displaying content may include display 104 (e.g., computer 254, mobile phone 272, or a portable digital assistant (not shown)).

The exemplary configuration of devices in network 200 is illustrated for simplicity. In some embodiments, the functions performed by two or more devices may be performed by any one device. Likewise, in some embodiments, the functions performed by any one device may be performed multiple devices. Further, the connections shown in FIG. 2 are exemplary. In other embodiments, additional connections that are not shown in FIG. 2 may exist between devices (e.g., each device may be connected to every other device). The connections in FIG. 2 may also be wireless or wired.

Network 200 may include more devices, fewer devices, or a different configuration of devices than illustrated in FIG. 2. For example, customer premises 250 may include additional devices, such as switches, gateways, routers, customer premise equipment, etc., that aid in routing data. As another example, in one embodiment, customer premises 250 may include a cable modem (not shown) to connect video client 256 to content server 242 through a coaxial cable. As another example, network 200 may include thousands or millions of customer homes.

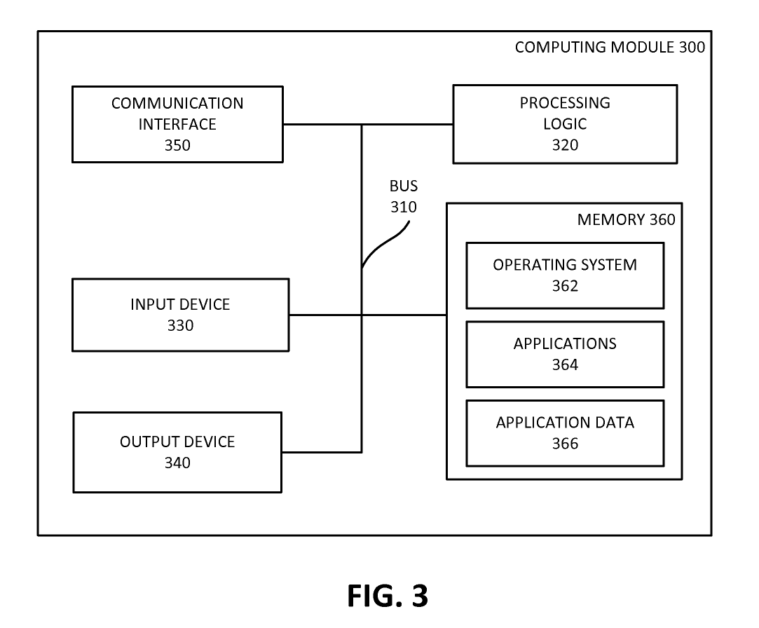

FIG. 3 is a block diagram of exemplary components of a computing module 300. Devices in network 200 may each include one or more computing modules 300. Computing module 300 may include a bus 310, processing logic 320, an input device 330, an output device 340, a communication interface 350, and a memory 360. Computing module 300 may include other components (not shown) that aid in receiving, transmitting, and/or processing data. Moreover, other configurations of components in computing module 300 are possible.

Bus 310 may include a path that permits communication among the components of computing module 300. Processing logic 320 may include any type of processor or microprocessor (or families of processors or microprocessors) that interprets and executes instructions. In other embodiments, processing logic 320 may include an application-specific integrated circuit (ASIC), a field-programmable gate array (FPGA), or the like.

Input device 330 may allow a user to input information into computing module 300. Input device 330 may include a keyboard, a mouse, a pen, a microphone, a remote control (e.g., remote control 258), a touch-screen display, etc. Some devices, such servers 232-238 may be managed remotely and may not include input device 330. In other words, some devices may be “headless” and may not include a keyboard, for example.

Output device 340 may output information to the user. Output device 340 may include a display, a printer, a speaker, etc. For example, TV 102 includes display 104 (an output device), which may include a liquid-crystal display (LCD) for displaying content to the user. As another example, ONT 252 and video client 256 may include light-emitting diodes (LEDs). Headless devices, such as servers 212-242, may be managed remotely and may not include output device 340.

Input device 330 and output device 340 may allow the user to activate and interact with a particular service or application, such as a content recommendation application, in video client 256. Input device 330 and output device 340 may allow the user to receive and view a menu of options and select from the menu options. The menu may allow the user to select various functions or services associated with applications executed by computing module 300.

Communication interface 350 may include a transceiver that enables computing module 300 to communicate with other devices and/or systems. Communication interface 350 may include a transmitter that may convert baseband signals to radio frequency (RF) signals and/or a receiver that may convert RF signals to baseband signals. Communication interface 350 may be coupled to an antenna for transmitting and receiving RF signals. Communication interface 350 may include a network interface card, e.g., Ethernet card, for wired communications or a wireless network interface (e.g., a WiFi) card for wireless communications. Communication interface 350 may also include, for example, a universal serial bus (USB) port for communications over a cable, a Bluetooth™ wireless interface, etc.

Memory 360 may store, among other things, instructions (e.g., applications 364 and operating system (OS) 362) and data (e.g., application data 366). Memory 360 may include a random access memory (RAM) or another type of dynamic storage device that may store information and instructions; a read-only memory (ROM) device or another type of static storage device that may store static information and instructions for use by processing logic 320; and/or some other type of magnetic or optical recording medium and its corresponding drive, e.g., a hard disk drive (HDD), for storing information and/or instructions.

OS 362 may include software instructions for managing hardware and software resources of computing module 300. For example, OS 362 may include Linux, Windows, OS X, an embedded operating system, etc. Applications 364 and application data 366 may provide network services or include applications, depending on the device in which the particular computing module 300 is found.

Computing module 300 may perform the operations described herein in response to processing logic 320 executing software instructions contained in a computer-readable medium, such as memory 360. A computer-readable medium include a physical or logical memory device. The software instructions may be read into memory 360 from another computer-readable medium or from another device via communication interface 350. The software instructions contained in memory 360 may cause processing logic 320 to perform processes that are described herein.

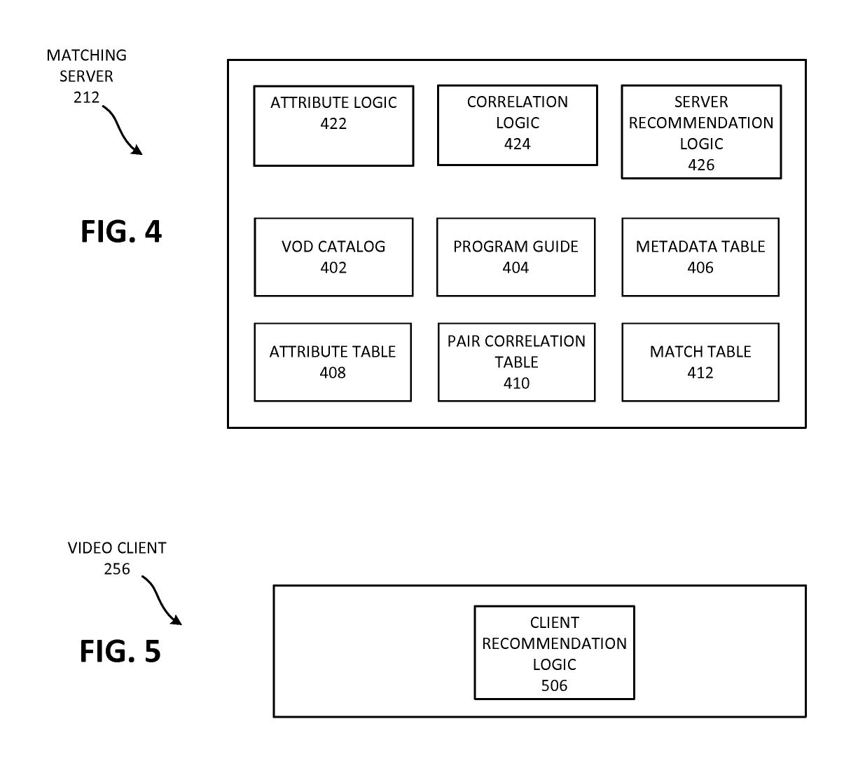

FIG. 4 is a block diagram of exemplary functional components and/or memory components of matching server 212 (e.g., functions performed by application 364 in processing logic 320 or stored in memory 360 of matching server 212). Matching server 212 may store video-on-demand (VOD) catalog 402, program guide 404, metadata table 406, attribute table 408, correlation table 410, and match table 412. Matching server 212 may also include attribute logic 422, correlation logic 424, and server recommendation logic 426.

VOD catalog 402 may identify content stored in on-demand server 232, for example, for delivery to video client 256. Program guide 404 may identify the content and broadcast times associated with, for example, content stored in regional content server 234 or national content server 222.

Metadata table 406 may store information about content provided by content servers 222-238, such as the title, genre, plot, cast, etc., of the content. Attribute table 408 may include information (e.g., a subset or the more relevant information) from metadata table 406. Metadata table 406 and/or attribute table 408 may be used for correlating, matching, and recommending content.

Correlation table 410 and match table 412 may both store information related to the degree of similarity between content. Match table 412 may store the information in a format better suited for real-time recommendation of content to a user.

Attribute logic 422 may distill the information in metadata table 406, for example, to generate attribute table 408. Correlation logic 424 may compare pieces of content (e.g., by comparing information stored in metadata table 406 and/or attribute table 408) and may generate correlation table 410 and/or match table 412. Server recommendation logic 426 may analyze correlation table 410 and/or match table 412 to determine content to recommend to the user of video client 256.

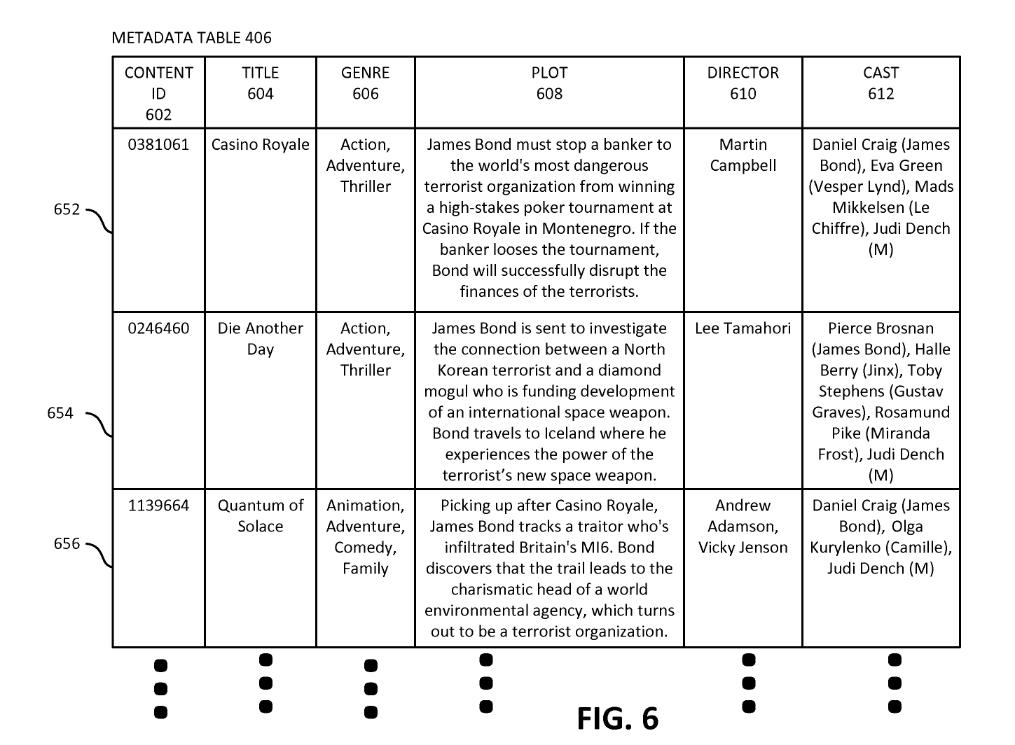

FIG. 5 is a block diagram of exemplary functional components and/or memory components of video client 256 (e.g., functions performed by application 364 by processing logic 320 or stored in memory 360 of video client 256). Video client 256 may include client recommendation logic 506. Client recommendation logic 506 may interact with server recommendation logic 426 to recommend content to a user and to receive input (e.g., instructions to record content) from the user regarding the recommended content.

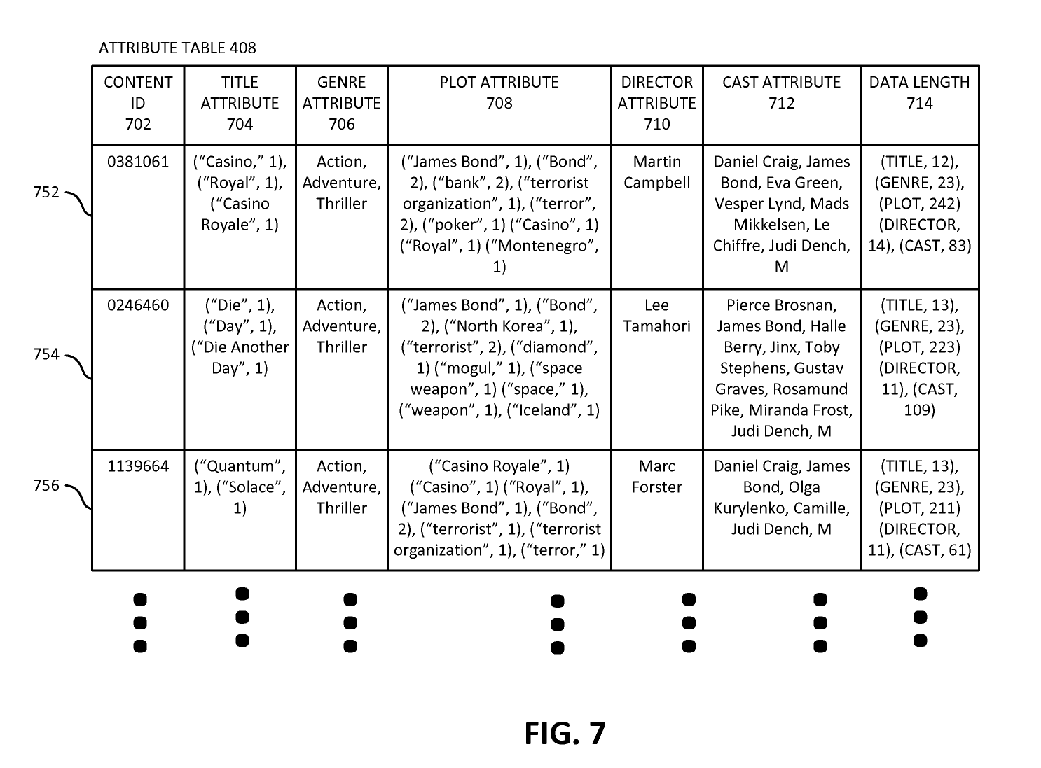

As described above, matching server 212 and/or metadata database 214 may include metadata table 406, which stores information related to or describing content. FIG. 6 is a diagram of exemplary metadata table 406. Each record (e.g., entry) in metadata table 406 may be associated with a different piece of content. Metadata table 406 may include a content ID field 602, a title field 604, a genre field 606, a plot field 608, a director field 610, and a cast field 612.

Content ID field 602 may include a value identifying a piece of content stored in a content server, such content servers 222-238. In one embodiment, content ID field 602 may uniquely identify the content. Record 652 of metadata table 406, for example, includes a content ID of 0381061 in content ID field 602.

Title field 604 may include the title of the associated content. Record 652 of metadata table 406 includes a title of “Casino Royale” in title field 604, for example. Genre field 606 may include a list of categories describing the content. Examples of genre include “action,” “adventure,” “thriller,” “sci-fi,” “comedy,” “romantic,” etc. Record 652 of metadata table 406 includes the following list of genres in genre field 606: action, adventure, and thriller.

Plot field 608 may include a description of the plot of the associated content. For example, record 652 includes the following plot in plot field 608: “James Bond must stop a banker to the world's most dangerous terrorist organization from winning a high-stakes poker tournament at Casino Royale in Montenegro. If the banker looses the poker tournament, Bond will successfully disrupt the finances of the terrorist organization.”

Director field 610 may include a list of names of the directors of the associated content. Record 652 of metadata table 406 includes the following list of names (e.g., a single name) in director field 606: Martin Campbell. Cast field 612 may include a list of names of the actors (and character played) that appear in the associated content. Record 652 of metadata table 406 includes the following list of names (with character played in parentheses) in cast field 612: Daniel Craig (James Bond), Eva Green (Vesper Lynd), Mads Mikkelsen (Le Chiffre), Judi Dench (M).

Metadata table 406 may include additional, different, or fewer fields than illustrated in FIG. 6. For example, metadata table 406 may include a writer field that may include the names of the authors of the content. Metadata table 406 may also include a channel field with the name of the channel that a piece of content is associated with playing (e.g., The History Channel, Discovery Channel, etc. etc.). As another example, metadata table 406 may include a date field indicating the date that the content was released to the public. Metadata table 406 may include a content-type field indicating the type of content (e.g., a movie, an interactive game, a TV program, etc.). In other embodiments, metadata table 406 may be stored in any other device in network 200, such as video client 256 or content servers 222-238 (e.g., in memory 360).

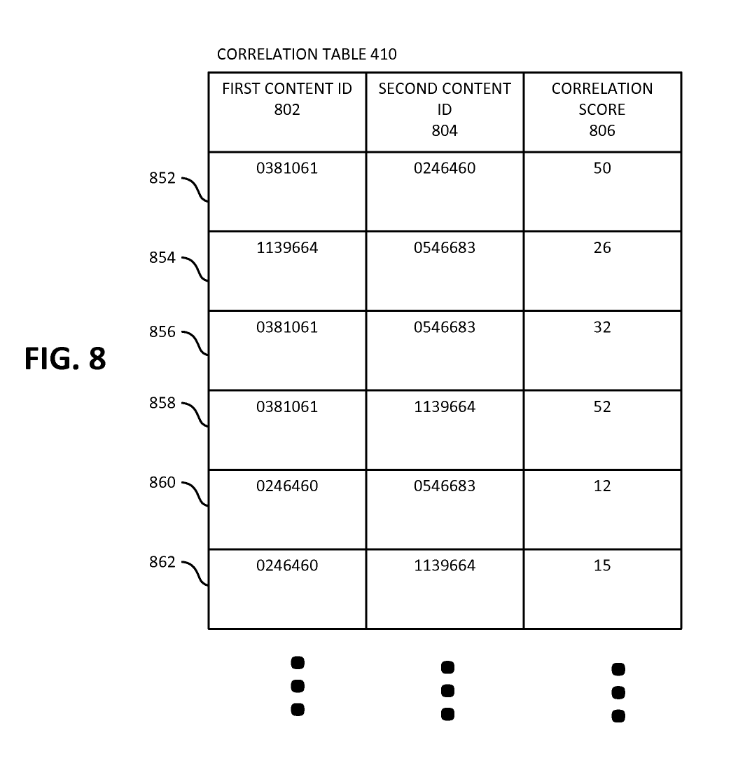

As described above, matching server 212 may also include attribute table 406, which stores information from metadata table 406 (e.g., a subset of information, the more relevant information, or attribute information). FIG. 7 is a diagram of exemplary attribute table 408. Attribute table 408 may be used for scoring, matching, and recommending content. Attribute table 408 may be generated, for example, by attribute logic 422.

Each record (e.g., entry) in attribute table 408 may be associated with a different piece of content. Further, in one embodiment, attribute table 408 may include a record corresponding to each record of metadata table 406. For example, exemplary attribute table 408 includes a record 752 that corresponds to record 652 in metadata table 406. That is, record 752 in attribute table 408 includes information (e.g., a subset of information or the more relevant information) from record 652 of metadata table 406. Likewise, record 754 corresponds to record 654 in metadata table 406 and record 756 corresponds to record 656 in metadata table 406.

In one embodiment, attribute table 408 includes fields that correspond to fields in metadata table 406. For example, attribute table 408 may include a content ID field 702, a title attribute field 704, a genre attribute field 706, a plot attribute field 708, a director attribute field 710, and a cast attribute field 712. These fields 702-712 may correspond (and include a subset of information from) content ID field 602, title field 604, genre field 606, plot field 608, director field 610, and cast field 612 in metadata table 406. Further, attribute table 608 may include additional fields regarding the attributes of information in metadata table 406. For example, attribute table 408 includes a data length field 714 that may store a list of the length of the data in fields 604-612 of metadata table 406.

Like content ID field 602 in metadata table 406, content ID field 702 may include a value (e.g., a unique value) identifying a piece of content stored in a content server, such as content servers 222-238. For example, record 702 includes a content ID of 0381061 (e.g., the same value as in content ID field 602 of record 652) in content ID field 702.

Title attribute field 704 may include information about the attributes of title field 602 corresponding to the same content ID. For example, record 754 includes title attributes of “Die”, “Day”, and “Die Another Day” in a list in title attribute field 704 (corresponding to “Die Another Day” in title field 604 of record 654). In the embodiment shown in FIG. 7, the list in title attribute field 704 includes a number indicating the number of times the attribute occurs in the respective field in metadata table 406.

Genre attribute field 706 may include information about the attributes of genre field 606 corresponding to the same content ID. In exemplary attribute table 408, genre attribute field 706 includes the same information as in genre attribute field 606. For example, record 752 includes the following list of genres in genre attribute field 706: action, adventure, and thriller. Genre attribute field 706, in this example, does not include a count number (unlike title attribute field 704) because it is assumed that each attribute occurs only once.

Plot attribute field 708 may include information about the attributes of plot field 608 corresponding to the same content ID. For example, record 752 includes the following list of attributes in plot attribute field 708: James Bond, Bond, bank, terrorist, organization, terror, poker, Casino, Royal, and Montenegro. In the embodiment shown in FIG. 7, the list in plot attribute field 706 includes a number indicating the number of times the attribute occurs in the respective field in metadata table 406. For example, the attribute “terrorist” occurs twice in plot field 608 in metadata table 406 (e.g., once in the first sentence and once in the second sentence of the plot). Attributes in plot attribute field 708 may include stemmed words and phrases. For example, the attribute “terror” is the stem (or root) of the word “terrorist.” Recording stemmed words in attribute table 408 may, for example, help correlation logic 424 properly correlate content having the same features but expressed differently.

Director attribute field 710 may include information about the attributes of director field 610 corresponding to the same content ID. In exemplary attribute table 408, director attribute field 710 includes the same information as in director field 610. For example, record 752 includes the following list of directors in director attribute field 710: Martin Campbell. Director attribute field 710, in this example, does not include a count number (unlike plot attribute field 708) because it is assumed that each attribute occurs only once.

Cast attribute field 712 may include information about the attributes of cast field 612 in metadata table 406. In the example of attribute table 408, cast attribute field 712 includes a list of names of the actors and characters played by those actors corresponding to the content ID. Record 752 includes the following list of actors and characters in cast attribute field 706: Daniel Craig, James Bond, Eva Green, Vesper Lynd, Mds Mikkelsen, Le Chiffre, Judi Dench, and M. Cast attribute field 712, in this example, does not include a count number (unlike plot attribute field 708) because it is assumed that each attribute occurs only once.

As mentioned above, attribute table 408 may include a data length field 714 that may store a list of the length of the data in fields 604-612 of metadata table 406. Data length field 714 may store the length of the data as the number of characters (including or not including spaces), as the number of words (including or not including less relevant words such as “a”, “the”, etc.).

Attribute table 408 may include additional, different, or fewer fields than illustrated in FIG. 7. For example, attribute table 408 may include a content-type field indicating the type of content (e.g., a movie, an interactive game, a TV program, etc.). Attribute table 408 may also include a channel attribute field with attributes of the channel a piece of content is associated with (e.g., history, documentary, movie, etc.). As another example, attribute table 408 may include a field or other information to indicate if a phrase is a stemmed phrase or a non-stemmed phrase. In other embodiments, attribute table 408 may be stored in any other device in network 200, such as in video client 256 or content servers 222-238 (e.g., in memory 360).

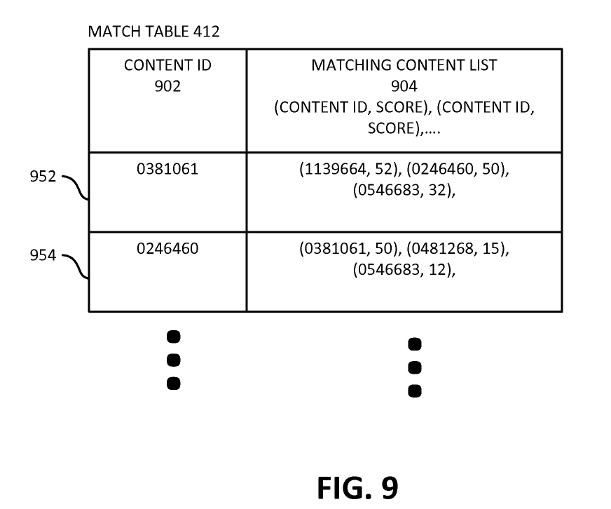

As discussed above, matching server 212 may also store correlation table 410. FIG. 8 is a diagram of an exemplary correlation table 410. Correlation table 410 may store information related to the similarities between (e.g., the correlation of) different content. Each record (e.g., entry) in correlation table 410 may be associated with a pair of pieces of content. Correlation table 410 may include a first content ID field 802, a second content ID field 804, and a correlation score field 806 (“score field 806”).

First content ID field 802 may include a value (e.g., a unique value) identifying a piece of content stored in a content server. For example, record 852 includes a content ID of 0381061 in first content ID field 802 (which corresponds to record 652 in metadata table 406 and record 752 in attribute table 408). Second content ID field 804 may also include a value (e.g., a unique value) identifying a piece of content stored in a content server. For example, record 852 includes a second content ID of 0246460 in second content ID field 802 (which corresponds to record 654 in metadata table 406 and record 754 in attribute table 408).

Score field 806 may include a value indicating the relative similarities between the content identified in first content ID field 802 and the content identified in second content ID field 804. In one embodiment, the higher the score, the more the pieces of content are considered to be similar or correlated, for example. The values in score field 806 may be generated, for example, by correlation logic 424.

As shown in record 852 of exemplary correlation table 410, the content with the ID of 0381061 (e.g., “Casino Royale”) and the content with the ID of 0246460 (e.g., “Die Another Day”) have a correlation score of 50. As shown in record 858 of correlation table 410, the content with the ID of 0381061 and the content with the ID of 1139664 have a correlation score of 52. In the example where higher scores indicate more similar content, the content pair in record 858 is considered more similar than the content pair in record 852 because the correlation score in score field 806 is higher in record 858 than in record 852.

Correlation table 410 may include additional, different, or fewer fields than illustrated in FIG. 8. For example, correlation table 410 may include additional fields for correlation scores calculated using different algorithms. In other embodiments, correlation table 410 may be stored in any other device in network 200, such as in video client 256 or content servers 222-238 (e.g., in memory 360).

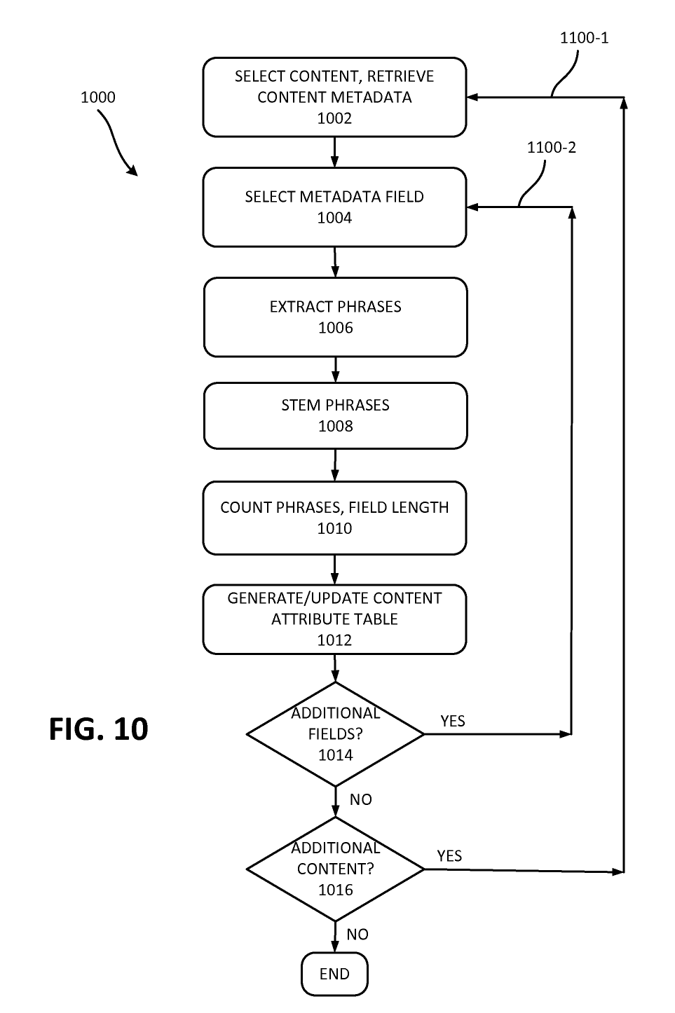

As discussed above, matching server 212 may also store match table 412. FIG. 9 is a diagram of an exemplary match table 412. Like correlation table 410, match table 412 may store information related to the similarities between (e.g., the correlation of) different content. In one embodiment, match table 412 may include the same correlation scores stored in correlation table 410 but organized differently. For example, each record (e.g., entry) in match table 412 may be associated with a different piece of content and may include a list of matching content and correlation scores associated with the matching content. Match table 412 may be generated, for example, by correlation logic 424.

Match table 412 may include a content ID field 902 and a matching content list field 904. Content ID field 902 may include a value (e.g., a unique value) identifying a piece of content stored in a content server. For example, record 952 includes a content ID of 0381061 in content ID field 602 (e.g., corresponding to record 652 in metadata table 406 and record 752 in attribute table 408). Record 954 includes a content ID of 0246460 in content ID field 902 (e.g., corresponding to record 654 in metadata table 406 and record 656 in attribute table 408).

Matching content list field 904 may include a list of the content that has been correlated with the corresponding content identified in content ID field 902. Matching content list field 904 may also include the correlation score associated with the listed matching content. For example, as shown in record 952 of exemplary match table 412, the content with ID 0381061 has been scored against the content with IDs 1139664, 0246460, and 0546683. The corresponding correlation scores in record 952 are 52, 50, and 32. As shown in record 954 of exemplary match table 412, the content with ID 0246460 as been scored against the content with IDs 0381061, 0481268, and 0546683. The corresponding correlation scores in record 954 are 50, 15, and 12.

Match table 412 may include additional, different, or fewer fields than illustrated in FIG. 9. For example, match table 410 may include additional fields for correlation scores calculated using different algorithms. As another example, matching content list field 904 may store a list of matching content IDs in order of rank without storing the corresponding correlation score associated with the matching content. In other embodiments, match table 412 may be stored in any other device in network 200, such as in video client 256 or content servers 222-238 (e.g., in memory 360).

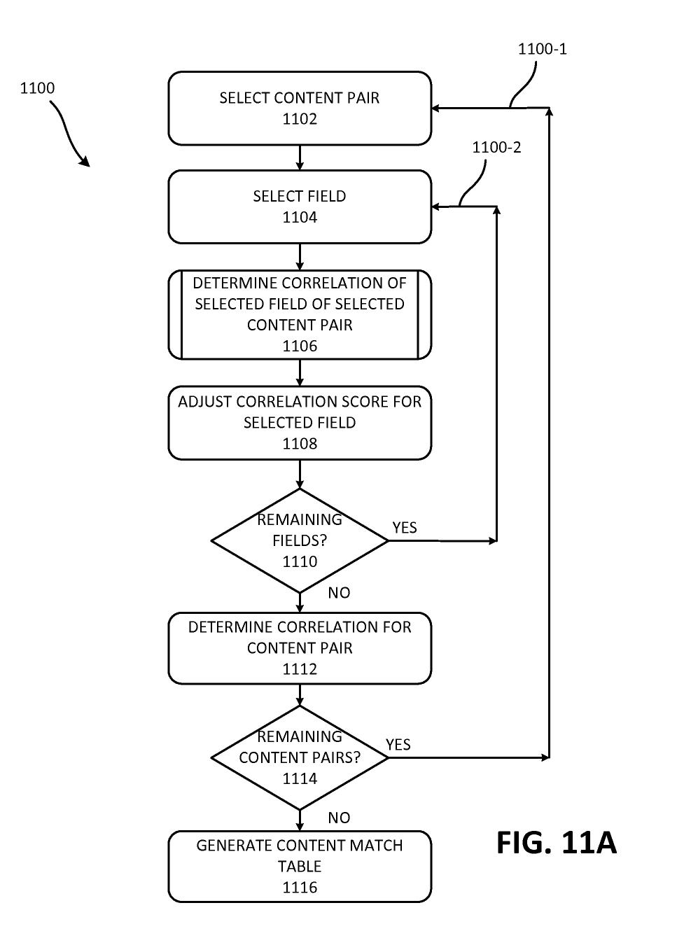

As discussed above, attribute logic 422 may determine the attributes of content by receiving metadata table 406 and generating attribute table 408. FIG. 10 is a flowchart of an exemplary process 1000, which may be performed by attribute logic 422, for determining attributes of content. As shown in FIG. 10, in one embodiment, process 1000 includes two loops, e.g., loop 1000-1 and loop 1000-2. In this embodiment, loop 1000-1 may cycle through metadata records for different pieces of content and loop 1000-2 may cycle through the metadata fields for the content.

Process 1000 may begin with the selection of a piece of content and the retrieval of the metadata associated with the selected content (block 1002). For example, if “Casino Royale” is selected, then record 652 for content ID 0381061 may be retrieved.

A field may be selected (block 1004). For example, plot field 608 of metadata table 406 may be selected. Phrases (e.g., key phrases) may be extracted (block 1006) from the selected field. In the case of plot field 608, extracted phrases may include “James Bond”, “Bond”, “banker”, “terrorist”, “terrorist organization”, “poker”, “Casino” “Royale”, and “Montenegro”. In one embodiment, the phrases may include one or two words. In another embodiment, phrases may also include three words. In yet another embodiment, phrases may include four or more than four words.

The extracted phrases may be stemmed (block 1008). Stemming a phrase may include determining the root of a word in the phrase. For example, “fairness” may become “fair” after stemming. In the current example, “banker” may become “bank”, “terrorist” may become “terror”, and “Royale” may become “Royal.” In one embodiment, the stemmed phrases may replace the corresponding non-stemmed extracted phrases. In another embodiment, the stemmed phrases may be added to the list of non-stemmed phrases. As shown in FIG. 7, phrases (some stemmed and some non-stemmed) appear in a list in plot attribute field 708 of record 752 corresponding to “Casino Royale” and content ID of 0381061.

The phrases and the field length may be counted (block 1010). Counting phrases may include counting the number of time a phrase (stemmed or non-stemmed) appears. In the current example, “James Bond” appears once, “Bond” appears twice, “bank” (stemmed from “banker”) appears twice, “terrorist organization” appears once, and “terror” (stemmed from “terrorist”) appears twice. As shown in FIG. 7, these counts appear in the list of phrases in plot attribute field 708 (next to the phrase) of record 752. In one embodiment, in addition to counting phrases, the length of the selected field may also be counted. For example, the length of plot field 608 may be recorded in a data length field 714 of attribute table 408.

The attribute table may be generated or updated (block 1012). As discussed with blocks 1008 and 1010, attribute table 408 may be updated to include the phrases (e.g., the extracted and/or the stemmed phrases), the count number for each phrase, and the field length. In plot attribute field 708 of record 752, the phrases appear in quotes and the count appears next to the phrase. In other fields, the count number for each phrase is assumed to be “1”, such as with the genre attribute field 706, the cast attribute field 712, and the director attribute field 710.

If there are additional fields (block 1014: YES), then another metadata field may be selected (block 1004). Blocks 1004 through 1012 may repeat until all desired fields from metadata table 406 are distilled into attribute table 408. For example, for record 752, title field 604 of metadata table 406 is distilled into title attribute field 704, genre field 606 is distilled into genre attribute field 706, director field 610 is distilled into director attribute field 710, and cast field 612 is distilled into cast attribute field 712.

If there is additional content (block 1016: YES), then another piece of content may be selected (block 1002). Blocks 1004 through 1012 may repeat until all fields from all pieces of content are distilled into attribute table 408. As shown in FIG. 7, record 654 of metadata table 406 is distilled into record 754 of attribute table 408 and record 656 of metadata table 406 is distilled into record 756 of attribute table 408.

The creation of attribute table 408 may allow correlation logic 424 to more easily correlate content without recreating attribute information for each correlation. In another embodiment, however, correlation logic 424 may determine the attributes of a piece of content each time the content is correlated with another piece of content.

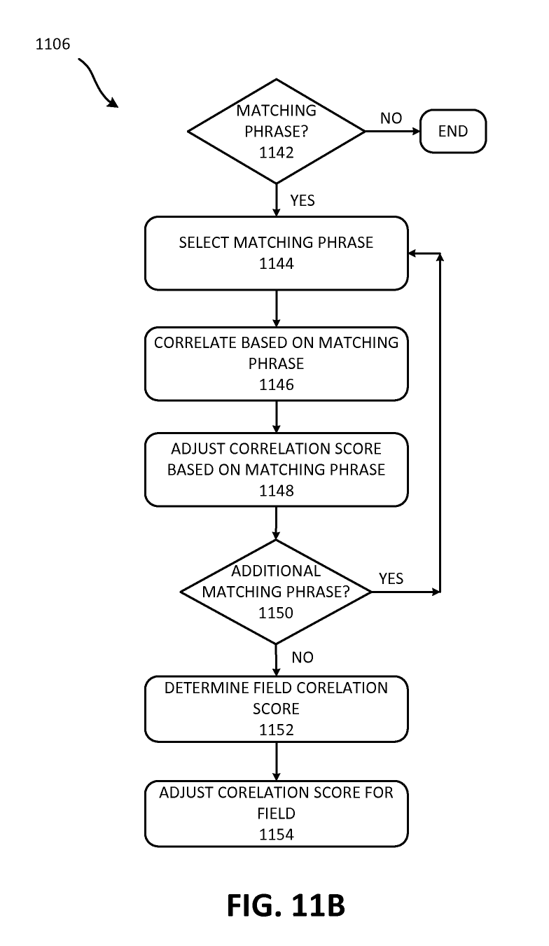

Armed with attribute table 408, correlation logic 424 may correlate content to generate correlation table 410. FIG. 11A is a flowchart of an exemplary process 1100 for correlating content, which may be performed by correlation logic 424. As shown in FIG. 11A, in one embodiment, process 1100 includes two loops, e.g., loop 1100-1 and loop 1100-2. In this embodiment, loop 1100-1 may cycle through different pairs of content, correlating the pair and giving each pair a correlation score. Loop 1100-2 may cycle through the fields in attribute table 408, correlating the data stored in each field of the pair of content. That is, correlation logic 424 may correlate attribute fields of the content pair and, using the results of the correlations of the attribute fields, may determine the correlation of the content pair. In this embodiment, the correlation score for the content pair may be based on the correlation of the fields of the content pair.

Process 1100 may begin with the selection of a content pair (block 1102). In one embodiment, process 1100 selects two pieces of content that have entries in attribute table 408 and that have not already been correlated. For example, process 1100 may select “Casino Royale” (e.g., content ID of 0381061) and “Die Another Day” (e.g., content ID of 0246460).

A field (e.g., an attribute field in attribute table 408) may be selected (block 1104). In one embodiment, process 1100 may select a field in attribute table 408 that has not already been used for correlating the content pair. For example, process 1100 may select plot attribute field 708 for correlation.

The correlation of the selected field for the selected content pair may be determined (block 1106). In other words, the similarity of the data in a field shared by the content pair may be determined and scored. For example, if process 1100 selected plot attribute field 708 for the content pair “Casino Royale” and “Die Another Day,” then process 1100 may score the similarity of the plots of this selected pair of content. One way of determining the correlation between data of a field is discussed below with respect to FIG. 11B. The degree of correlation may be recorded as a “correlation score.”

In one embodiment, the correlation score of some attribute fields may indicate correlation better than other fields. In this embodiment, the correlation score for the selected field may be adjusted (e.g., weighted) (block 1108). For example, plot attribute field 704 or title attribute field 702 may indicate the correlation between content pairs better than director attribute field 710. Thus, the correlation of title attribute field 702 may be weighted by a factor of 2, for example, and the correlation of director attribute field 710 may be weighted by a factor of 1. Weighing may give one attribute field (e.g., plot attribute field 708) greater influence in the final correlation score (determined below) than another field (e.g., director attribute field 710). In another embodiment, the correlation score for the selected field may not be adjusted. In yet another embodiment, the correlation score for the selected field may be weighed by a factor of 0 (zero). In this embodiment, the correlation score for the selected field may not have any influence on the final correlation score. In one embodiment, title attribute field 702 and genre attribute field 706 are given the highest weights relative to the other fields.

If there are any remaining fields (block 1110: YES), then another field may be selected (block 1104), correlated (block 1106), and adjusted (block 1108). In other words, in one embodiment, data in an additional field of attribute table 408 of the selected content pair may be correlated (and adjusted) until all the desired fields are correlated.

Once no more fields remain for the content pair (block 1110: NO), then the correlation for the content pair may be determined (block 1112). In one embodiment, the correlation of the content pair may be determined by summing the correlation scores (e.g., adjusted correlation scores) for all the correlated fields. The correlation score for a content pair may be recorded in correlation table 410.

If there are any content pairs that have not been correlated (block 1114: YES), then another content pair may be selected (block 1102), scored (blocks 1106, 1108, and 1112), and recorded in correlation table 410. Once all desired pairs of content have been correlated (block 1112: NO), then a match table may be generated (block 1116). For example, match table 412 may be generated from correlation table 410. In one embodiment, match table 412 may be generated concurrently with correlation table 410. In yet another embodiment, match table 412 may be generated instead of correlation table 410.

As discussed above, correlation logic 424 may correlate the data in a field for the selected content pair. FIG. 11B is a diagram of a flowchart of an exemplary process 1106 for correlating data in a field for a content pair. Process 1106 may begin with a content pair being selected (block 1102) and when a field is selected for the content pair (block 1104). For example, in the example given above for process 1100, plot attribute field 708 may have been selected for the content pair “Casino Royale” (content ID 0381061) and “Die Another Day” (content ID 0246460).

Process 1106 may determine whether the content pair has a matching phrase in the selected field (block 1142). For example, plot attribute field 708 for record 752 (corresponding to “Casino Royale”) and record 754 (corresponding to “Die Another Day”) both have the following phrases in common: James Bond, Bond, terrorist, and terror. If the content pair has a matching phrase for the selected field (block 1142: YES), then a phrase may be selected (block 1144). In the current example, the phrase “James Bond” may be selected.

The field for the content pair may be correlated based on the matching phrase (block 1146). In one embodiment, a field the correlation score may be determined by taking the mean (e.g., geometric mean, arithmetic mean, weighted mean, harmonic mean, etc.) of the number of occurrences of the phrase from each pair of content. For example, the arithmetic mean of the number of occurrences of the phrase “James Bond” is 2. The geometric mean (e.g., the square root of the product of the number of occurrences) of the number of occurrences of the phrase “James Bond” is also 2.

Some phrases may indicate correlation of content pairs better than other phrases. Therefore, the correlation score for the phrase may be adjusted (block 1148). For example, words or phrases that occur less frequently in the English language (or any other language) may indicate a correlation between content pairs better than words or phrases that occur more frequently. Thus, words or phrases that occur less frequently may be weighted heavier than words or phrases that occur more frequently. Such weighing may give less frequently used words and phrases more weight in the correlation of the field, and ultimately the correlation score of the content pair. As another example, if a stemmed phrase and the corresponding non-stemmed phrase are recorded in attribute table 408, and both are matching phrases, then these stemmed and non-stemmed phrases may be reduced in weight so as not to double count the phrase. In one embodiment, the correlation score for the selected phrase may not be adjusted.

If there is an additional matching phrase (block 1150: YES), then another phrase may be selected (block 1144), scored (block 1146) and adjusted (block 1148). If there is no additional matching phrase (block 1150: NO), then the correlation score for the field may be determined (block 1152). In one embodiment, the correlation score for the field may be the sum of the (adjusted) correlation scores for the matching phrases of the selected field.

The correlation score for the field may be adjusted (e.g., weighed) (block 1154). As discussed above, some fields may indicate correlation better than other fields. For example, matching phrases in shorter sets of data may indicate correlation better than longer sets of data for the same matching phrases. Thus, title attribute field 704, in this example, may indicate correlation better than plot attribute field 708 because the corresponding title field 604 is shorter than the corresponding plot field 608. To adjust the correlation score for a field, the correlation score may be divided by the length of the data stored in both records in the selected field. In another embodiment, the correlation score for the selected field may be divided by the square root of the sum of the lengths of the data stored in both records in the selected field. In another embodiment, the correlation score for the selected field may be divided by the mean (e.g., the arithmetic mean, geometric mean, etc.) of the lengths of the data stored in both records in the selected field. In another embodiment, a constant (e.g., 50) may be added to any such divisor discussed above. In this embodiment, adding 50 to the divisor may smooth the resulting values for short data fields. These adjustments may give title attribute field 704 greater influence, for example, in the total correlation score than plot attribute field 708.

In another embodiment, the correlation score for title attribute field 704 may be weighted by a factor of 2, for example, and the correlation score for plot attribute field 708 may be weighted by a factor of 1 when adjusting the correlation score for these fields (block 1154).

The adjustment performed in block 1154 may also be performed in block 1108 discussed above in process 1100. Additionally, some adjustments performed in block 1154 may be performed in block 1108, depending on the properties of the adjustments (e.g., if the adjustment includes a distributive property).

After the correlation score for the field is adjusted, the score may be passed to process 1100 for the content pair correlation score to be determined.

Alternatives to the process 1106 are possible. For example, process 1106 may correlate different fields from a content pair (e.g., correlate Title attribution field 704 of one record with plot field 708 of another record). As another example, process 1106 may correlate fields from different types of content that do not necessarily have the same metadata fields (e.g., a field from an interactive game may be correlated with a field from a movie). In this example, a James Bond interactive game may be recommended to someone watching “Casino Royale.”

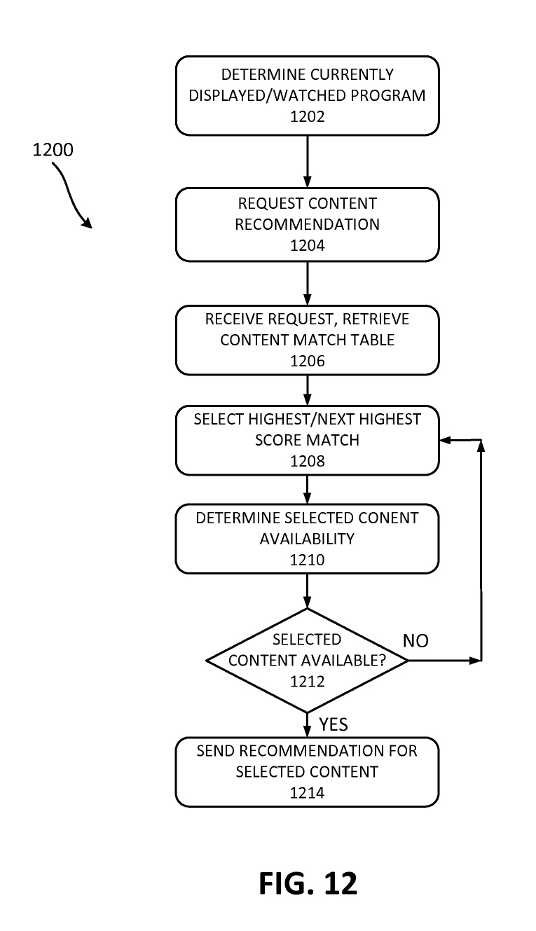

The correlation scores determined above may be used to recommend content to users. FIG. 12 is a flowchart of an exemplary process 1200 for recommending content. Process 1200 may recommend content based on match table 412, for example, generated in process 1100 and 1106. In one embodiment, server recommendation logic 426 (in matching server 212) and client recommendation logic 506 (in video client 256) may perform process 1200.

Process 1200 may begin with the determination of the program (e.g., television program) currently being displayed for a user to watch (block 1202). For example, referring to FIG. 1, at 3:30 pm (as indicated by widget 108) video client 256 may determine that program 106 (“Casino Royale,” content ID of 0381061) is currently being displayed on display 104 for the user to watch and that program 106 is playing between 3-5 pm. In one embodiment, the determination of the program that is being watched may be determined by another device, such as matching server 212 or content server 242. In one embodiment, the determination (block 1202) is made after a program has been playing for a period of time (e.g., 1, 2, 3, 5, 10, 15, 20, or 30 minutes into a program). Such a delay may indicate interest by the user in program 106.

A request for a recommendation for content may be placed (block 1204). In one embodiment, video client 256 may request a recommendation from matching server 212. The request may include the identification of program 106 (e.g., content ID 0381061). The request may be received, and the appropriate match table record retrieved (block 1206). Referring to FIG. 9, matching server 212 may receive the request and may retrieve record 952 in match table 412 corresponding to the content ID received in the request (e.g., 0381061).

The highest scoring matching content may be selected (block 1208). Referring to FIG. 9, the content with the highest correlation score has content ID of 1139664 (e.g., “Quantum of Solace”), which, in this example, is selected. The availability of the selected content may be determined (block 1210). For example, server recommendation logic 426 may query program guide 404 to determine when the selected content is available for viewing. In this example, the content with ID of 1139664 (“Quantum of Solace”) was available at 2 pm, a time that has already passed. Because 2 pm has already passed, the content with ID of 1139664 is considered unavailable. In one embodiment, server recommendation logic 426 may also query VOD catalog 402 to determine if the content with ID of 1139664 is available. In this example, VOD catalog 402 indicates that it does not store the content with ID of 1139664, and thus this content remains unavailable.

If the selected content is not available (block 1212: NO), then the next highest scoring matching content may be selected (block 1212). In the current example, because the content with ID of 1139664 is unavailable, referring to record 952 of match table 412, the next-highest scoring content (e.g., content ID of 0246460, “Die Another Day”) is selected. The availability of the next-selected content may be determined (block 1210). Server recommendation logic 426 in may query program guide 404 to determine when the selected content is available for viewing. In this example, the content with ID of 0246460 (“Die Another Day”) is available on channel 5 at 7 pm, a time that is in the future. Because 7 pm has not yet passed, the content with ID of 0246460 is considered available. In one embodiment, server recommendation logic 426 may also query VOD catalog 402 to determine whether the selected content is available in on-demand server 232.

In one embodiment, a time window may be used to determine whether to a program is available. For example, if the program is playing more than one hour in the future, then it may be considered unavailable. Other time windows include 2, 3, 4, 5, 10, 12, or 24 hours. In one embodiment, the time difference between the end of the current program and the start of the selected content may be used to adjust (e.g., weigh)

If the selected content is available (block 1212: YES), then the recommendation for the selected content may be sent (block 1214). Since the content with ID of 0246460 is available, server recommendation logic 426 may send the recommendation to video client 256. Video client 256 may display widget 112, for example, asking the user whether to record the content (e.g., “Die Another Day”) at 7 pm on channel 5. As mentioned above, the user may remote control 258 to select “Yes” or “No.” If the user selects “Yes,” then video client 256 may automatically record the program for later watching. If the recommended content is on-demand content, then the on-demand content may be displayed immediately after the current program has completed, for example.

As discussed above, embodiments disclosed herein allow real-time recommendation of content based on the content being displayed to a user (e.g., being watched by a user). Some embodiments, however, may provide non-real-time recommendation of content.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

While series of blocks have been described above with respect to different processes, the order of the blocks may differ in other implementations. Moreover, non-dependent acts may be performed in parallel.

It will be apparent that aspects of the embodiments, as described above, may be implemented in many different forms of software, firmware, and hardware in the embodiments illustrated in the figures. The actual software code or specialized control hardware used to implement these embodiments is not limiting of the invention. Thus, the operation and behavior of the embodiments of the invention were described without reference to the specific software code—it being understood that software and control hardware may be designed to the embodiments based on the description herein.

Further, certain portions of the invention may be implemented as logic that performs one or more functions. This logic may include hardware, such as an application specific integrated circuit, a field programmable gate array, a processor, or a microprocessor, or a combination of hardware and software.

No element, act, or instruction used in the description of the present application should be construed as critical or essential to the invention unless explicitly described as such. Also, as used herein, the articles “a” and the term “one of” are intended to include one or more items. Further, the phrase “based on” is intended to mean “based, at least in part, on” unless explicitly stated otherwise.

What is claimed is:

1. A computer-implemented method comprising:
determining a program currently being displayed for a user to watch;
selecting a program to recommend to the user based on the program currently being displayed and based on an availability of the program to recommend; and
displaying an indication of the recommended program to the user.

2. The computer-implemented method of claim 1, wherein selecting the recommended program based on the availability includes querying a program guide to determine that the recommended program is scheduled to broadcast in the future.

3. The computer-implemented method of claim 1, wherein selecting the recommended program based on the availability includes querying a video-on-demand catalog to determine that the recommended program is available on demand by the user.

4. The computer-implemented method of claim 1, wherein selecting the program to recommend includes selecting a program from a list of programs based on correlations between the program currently being displayed and each program in the list.

5. The computer-implemented method of claim 4, wherein selecting the program to recommend based on the availability includes querying a program guide or a video-on-demand catalog to determine that the selected program is scheduled to broadcast in the future or is available on demand by the user.

6. The computer-implemented method of claim 4, further comprising:
correlating the program currently being displayed with the recommended program,
wherein a first metadata describes the program currently being displayed and a second metadata describes the recommended program, and
wherein correlating includes determining whether the first metadata includes a phrase or a stemmed phrase that matches a phrase or a stemmed phrase in the second metadata.

7. The computer-implemented method of claim 6,
wherein the first metadata includes a first plurality of data fields and the second metadata includes a second plurality of data fields,
wherein correlating includes determining the correlation of each of the first plurality of data fields with one of the second plurality of data fields, and
wherein determining the correlation of each of the first plurality of data fields with one of the second plurality of data fields includes determining whether each of the first plurality of data fields includes a phrase or a stemmed phrase that matches a phrase or a stemmed phrase in one of the second plurality of data fields.

8. The computer-implemented method of claim 7, wherein determining the correlation includes
determining a first number of occurrences of the phrase or stemmed phrase in one of the first plurality of data fields and a second number of occurrences of the phrase or stemmed phrase in one of the second plurality of data fields; and
calculating the mean of the first number and the second number.

9. The computer-implemented method of claim 8, wherein calculating the mean includes calculating a geometric or an arithmetic mean of the first number and the second number.

10. The computer-implemented method of claim 7, wherein correlating includes:
adjusting or weighing the correlation of each of the first plurality of data fields with the second plurality of data fields, and
summing one or more of the correlations, the adjusted correlations, or the weighed correlations.

11. The computer-implemented method of claim 10, wherein adjusting the correlation includes determining a length of one of the first plurality of data fields or one of the second plurality of data fields, and adjusting the correlation based on the length.

12. A system comprising:
a network device including:
a processor to determine a program currently being displayed for a user to watch on a display of a user device, and to select a program to recommend to the user based on the program currently being displayed and based on an availability of the program to recommend; and
a transmitter to send an indication of the recommended program to the user device for the user device to display the indication of the recommended program the user.

13. The system of claim 12, further comprising a database to store a program guide, wherein the processor determines the availability of the recommended program by querying the program guide to determine that the recommended program is scheduled to broadcast in the future.

14. The system of claim 13, further comprising the user device, the user device including:
a receiver to receive the indication of the recommended program from the network device;
the display to display the indication of the recommended program to the user; and
a transmitter to send an instruction to record or display the recommended program in the future.

15. The system of claim 12, further comprising a database to store a video-on-demand catalog, wherein the processor queries the video-on-demand catalog to determine that the recommended program is available on demand by the user.

16. The system of claim 12, further comprising:
a database to store a list of programs and information indicative of correlations of the program currently being displayed with each program in the list, wherein the processor selects the recommended program from the list based on the information indicative of the correlations; and
a database to store a program guide or a video-on-demand catalog, wherein the processor queries the program guide or the video-on-demand catalog to determine that the selected program is scheduled to broadcast in the future or is available on demand by the user.

17. The system of claim 16, further comprising:
a database to store a first metadata describing the program currently being displayed and a second metadata describing the recommended program,
wherein the processor correlates the program currently being displayed and the recommended program based on whether the first metadata includes a phrase or a stemmed phrase that matches a phrase or a stemmed phrase in the second metadata.

18. The system of claim 17,
wherein the first metadata includes a first plurality of data fields and the second metadata includes a second plurality of data fields, and
wherein the processor determines a correlation of each of the first plurality of data fields with one of the second plurality of data fields based on a determination of whether each of the first plurality of data fields includes a phrase or a stemmed phrase that matches a phrase or a stemmed phrase in the one of the second plurality of data fields.

19. The system of claim 18,
wherein the processor determines a first number of occurrences of the phrase or stemmed phrase in one of the first plurality of data fields and a second number of occurrences of the phrase or stemmed phrase in one of the second plurality of data fields, and
wherein the processor determines the correlation based on a mean of the first number and the second number.

20. The computer-implemented method of claim 18, wherein the processor adjusts or weighs the correlation of each of the first plurality of data fields with one of the second plurality of data fields, and sums one or more of the correlations, the adjusted correlations, or the weighted correlations.

21. The computer-implemented method of claim 20, wherein the processor adjusts one of the correlations based on a length of one of the first plurality of data fields or a length of one of the second plurality of data fields.

22. A computer-implemented method comprising:
determining a program currently being displayed for a user to watch; and
selecting a program to recommend to the user based on the program currently being displayed and based on an availability of the recommended program,
wherein selecting the recommended program includes selecting a program from a list of programs based on information indicative of correlations of the program currently being displayed and each program in the list.

23. The computer-implemented method of claim 22, wherein selecting the program includes querying a program guide or a video-on-demand catalog to determine that the selected program is scheduled to broadcast in the future or is available on demand by the user.

24. The computer-implemented method of claim 23, the method further comprising:
correlating the program currently being displayed with the recommended program, wherein a first metadata, having a first plurality of data fields, describes the program currently being displayed and a second metadata, having a second plurality of data fields, describes the recommended program,
wherein correlating includes determining the correlation of each of the first plurality of data fields with one of the second plurality of data fields,
wherein determining the correlation of each of the first plurality of data fields with one of the second plurality of data fields includes determining whether each of the first plurality of data fields includes a phrase or a stemmed phrase that matches a phrase or a stemmed phrase in one of the second plurality of data fields, and
wherein determining the correlation includes determining a mean of a first number of occurrences of the phrase or stemmed phrase in one of the first plurality of data fields and a second number of occurrences of the phrase or stemmed phrase in one of the second plurality of data fields.

25. The computer-implemented method of claim 23, wherein correlating includes:
adjusting or weighing the correlation of each of the first plurality of data fields with the second plurality of data fields; and
summing one or more of the correlations, the adjusted correlations, or the weighed correlations.
